(19) United States
(12) Patent Application Publication
(10) Pub. No.: US 2026/0361925 A1
(43) Pub. Date: Nov. 12, 2026

(54) Method and Apparatus of Position-Aware Reconstruction in In-Loop Filtering

(71) Applicant: MEDIATEK INC., Hsinchu City (TW)

(72) Inventors: Shih-Chun CHIU, Hsinchu City (TW); Ching-Yeh CHEN, Hsinchu City (TW)

(21) Appl. No.: 19/121,250

(22) PCT Filed: Sep. 27, 2023
(86) PCT No.: PCT/CN2023/121900

§ 371 Date: Apr. 15, 2025

Related U.S. Application Data
(60) Provisional application No. 63/380,591, filed on Oct. 24, 2022.

(51) Int. Cl. H04N 19/82; H04N 19/117; H04N 19/132; H04N 19/46; H04N 19/86

(52) U.S. Cl. CPC H04N 19/82; H04N 19/117; H04N 19/132; H04N 19/46; H04N 19/86

(57) ABSTRACT

A method and apparatus for video coding using position-aware in-loop filtering. According to the method, a horizontal period M and a vertical period N are determined. Samples in the current coding region are divided into K positional groups according to sample positions with respect to the horizontal period M and the vertical period N. K in-loop filters are determined for the K positional groups, wherein any two of the K in-loop filters are different in at least one part of filtering process. A target filtered output for a target sample of the current coding region having a target positional group number is derived by applying a target in-loop filter to the target sample, wherein the target in-loop filter is selected from the K in-loop filters according to the target positional group number. Filtered-reconstructed pixels are provided, wherein the filtered-reconstructed pixels comprise the target filtered output.

### CROSS REFERENCE TO RELATED APPLICATIONS

The present invention is a non-Provisional Application of and claims priority to U.S. Provisional Patent Application No. 63/380,591, filed on Oct. 24, 2022. The U.S. Provisional Patent Applications are hereby incorporated by reference in their entireties.

### FIELD OF THE INVENTION

The present invention relates to in-loop filters in a video coding system. In particular, the present invention relates techniques that uses position-aware in-loop filtering process to improve the coding performance.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

### Adaptive Loop Filter in VVC

In VVC, an Adaptive Loop Filter (ALF) with block-based filter adaption is applied. For the luma component, one filter is selected among 25 filters for each 4×4 block, based on the direction and activity of local gradients.

### Filter Shape

Two diamond filter shapes (as shown in FIG. 2) are used. The 7×7 diamond shape 220 is applied for luma component and the 5×5 diamond shape 210 is applied for chroma components.

### Block Classification

For luma component, each 4×4 block is categorized into one out of 25 classes. The classification index C is derived based on its directionality D and a quantized value of activity Â, as follows:

C=5D+Â.

To calculate D and Â, gradients of the horizontal, vertical and two diagonal direction are first calculated using 1-D Laplacian:

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert ,$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert ,$$

$${g}_{d 1} = {\sum }_{k = i - 2}^{i + 3} {\sum }_{l = j - 2}^{j + 3} D {1}_{k , l} , D {1}_{k , l} = \vert 2 R ( k , l ) - R ( k - 1 , l - 1 ) - R ( k + 1 , l + 1 ) \vert ,$$

$${g}_{d 2} = {\sum }_{k = i - 2}^{i + 3} {\sum }_{l = j - 2}^{j + 3} D {2}_{k , l} , D {2}_{k , l} = \vert 2 R ( k , l ) - R ( k - 1 , l + 1 ) - R ( k + 1 , l - 1 ) \vert ,$$

where indices i and j refer to the coordinates of the upper left sample within the 4×4 block and R(i, j) indicates a reconstructed sample at coordinate (i, j).

To reduce the complexity of block classification, the subsampled 1-D Laplacian calculation is applied to the vertical direction (FIG. 3A) and the horizontal direction (FIG. 3B). As shown in FIGS. 3C-D, the same subsampled positions are used for gradient calculation of all directions (g_{d1} in FIG. 3C and g_{d2} in FIG. 3D).

Then D maximum and minimum values of the gradients of horizontal and vertical directions are set as:

$${g}_{h , v}^{max} = max ( {g}_{h} , {g}_{v} ) , {g}_{d 0 , d 1}^{min} = min ( {g}_{d 0} , {g}_{d 1} ) .$$

The maximum and minimum values of the gradient of two diagonal directions are set as:

$${g}_{d 0 , d 1}^{max} = max ( {g}_{d 0} , {g}_{d 1} ) , {g}_{d 0 , d 1}^{min} = min ( {g}_{d 0} , {g}_{d 1} ) .$$

To derive the value of the directionality D, these values are compared against each other and with two thresholds t₁ and t₂:
Step 1. If both

$${g}_{h , v}^{max} \leq {t}_{1} \cdot {g}_{h , v}^{min} and {g}_{d 0 , d 1}^{max} \leq {t}_{1} \cdot {g}_{d 0 , d 1}^{min}$$

are true, D is set to 0.
Step 2. If

$${g}_{h , v}^{max} / {g}_{h , v}^{min} > {g}_{d 0 , d 1}^{max} / {g}_{d 0 , d 1}^{min} ,$$

continue from Step 3; otherwise continue from Step 4.
Step 3. If

$${g}_{h , v}^{max} > {t}_{2} \cdot {g}_{h , v}^{min} ,$$

is set to 2; otherwise D is set to 1.
Step 4. If

$${g}_{d 0 , d 1}^{max} > {t}_{2} \cdot {g}_{d 0 , d 1}^{min} ,$$

is set to 4; otherwise D is set to 3.

The activity value A is calculated as:

$$A = {\sum }_{k = i - 2}^{i + 3} {\sum }_{l = j - 2}^{j + 3} ( {V}_{k , l} + {H}_{k , l} ) .$$

A is further quantized to the range of 0 to 4, inclusively, and the quantized value is denoted as Â.

For chroma components in a picture, no classification is applied.

### Geometric Transformations of Filter Coefficients and Clipping Values

Before filtering each 4×4 luma block, geometric transformations such as rotation or diagonal and vertical flipping are applied to the filter coefficients f(k, l) and to the corresponding filter clipping values c(k, l) depending on gradient values calculated for that block. This is equivalent to applying these transformations to the samples in the filter support region. The idea is to make different blocks to which ALF is applied more similar by aligning their directionality.

Three geometric transformations, including diagonal, vertical flip and rotation are introduced:
Diagonal: f_{D}(k, l)=f(l, k), c_{D}(k, l)=c(l, k),
Vertical flip: f_{V}(k, l)=f(k, K−l−1), c_{V}(k,l)=c(k,K−l−1),
Rotation: f_{R}(k, l)=f(K−l−1,k), C_{R}(k,l)=c(K−l−1,k),
   where K is the size of the filter and 0≤k, l≤K−1 are coefficients coordinates, such that location (0,0) is at the upper left corner and location (K−1, K−1) is at the lower right corner. The transformations are applied to the filter coefficients f(k, l) and to the clipping values c(k, l) depending on gradient values calculated for that block. The relationship between the transformation and the four gradients of the four directions are summarized in the following table.

TABLE 1
Mapping of the gradient calculated for
one block and the transformations

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

### Filtering Process

At decoder side, when ALF is enabled for a CTB (Coding Tree Block), each sample R(i, j) within the CU is filtered, resulting in sample value R′ (i, j) as shown below,

$${R}^{′} ( i , j ) = R ( i , j ) + ( ( {\sum }_{k \neq 0} {\sum }_{l \neq 0} f ( k , l ) \times K ( R ( i + k , j + l ) - R ( i , j ) , c ( k , l ) ) + 64 ) >> 7. )$$

where f(k, l) denotes the decoded filter coefficients, K(x, y) is the clipping function and c(k, l) denotes the decoded clipping parameters. The variable k and l varies between −L/2 and L/2, where L denotes the filter length. The clipping function K(x, y)=min(y, max(−y, x)) which corresponds to the function Clip3(−y, y, x). The clipping operation introduces non-linearity to make ALF more efficient by reducing the impact of neighbour sample values that are too different with the current sample value.

### Cross Component Adaptive Loop Filter

CC-ALF uses luma sample values to refine each chroma component by applying an adaptive, linear filter to the luma channel and then using the output of this filtering operation for chroma refinement. FIG. 4A provides a system level diagram of the CC-ALF process with respect to the SAO, luma ALF and chroma ALF processes. As shown in FIG. 4A, each colour component (i.e., Y, Cb and Cr) is processed by its respective SAO (i.e., SAO Luma 410, SAO Cb 412 and SAO Cr 414). After SAO, ALF Luma 420 is applied to the SAO-processed luma and ALF Chroma 430 is applied to SAO-processed Cb and Cr. However, there is a cross-component term from luma to a chroma component (i.e., CC-ALF Cb 422 and CC-ALF Cr 424). The outputs from the cross-component ALF are added (using adders 432 and 434 respectively) to the outputs from ALF Chroma 430.

Filtering in CC-ALF is accomplished by applying a linear, diamond shaped filter (e.g. filters 440 and 442 in FIG. 4B) to the luma channel. In FIG. 4B, a blank circle indicates a luma sample and a dot-filled circle indicate a chroma sample. One filter is used for each chroma channel, and the operation is expressed as:

$$Δ {I}_{i} ( x , y ) = {\sum }_{( {x}_{0} , {y}_{0} ) ∈ {S}_{i}} {I}_{0} ( {x}_{Y} + {x}_{0} , {y}_{Y} + {y}_{0} ) {c}_{i} ( {x}_{0} , {y}_{0} )$$

where (x, y) is chroma component i location being refined, (x_{Y}, y_{Y}) is the luma location based on (x, y), Sᵢ is filter support area in luma component, and cᵢ(x₀, y₀) represents the filter coefficients.

As shown in FIG. 4B, the luma filter support is the region collocated with the current chroma sample after accounting for the spatial scaling factor between the luma and chroma planes.

In the VVC reference software, CC-ALF filter coefficients are computed by minimizing the mean square error of each chroma channel with respect to the original chroma content. To achieve this, the VTM (VVC Test Model) algorithm uses a coefficient derivation process similar to the one used for chroma ALF. Specifically, a correlation matrix is derived, and the coefficients are computed using a Cholesky decomposition solver in an attempt to minimize a mean square error metric. In designing the filters, a maximum of 8 CC-ALF filters can be designed and transmitted per picture. The resulting filters are then indicated for each of the two chroma channels on a CTU basis.

### Additional Characteristics of CC-ALF Include:

The design uses a 3×4 diamond shape with 8 taps.
Seven filter coefficients are transmitted in the APS (Adaptation Parameter Set).
Each of the transmitted coefficients has a 6-bit dynamic range and is restricted to power-of −2 values.
The eighth filter coefficient is derived at the decoder such that the sum of the filter coefficients is equal to 0.
An APS may be referenced in the slice header.
CC-ALF filter selection is controlled at CTU-level for each chroma component.
Boundary padding for the horizontal virtual boundaries uses the same memory access pattern as luma ALF.

As an additional feature, the reference encoder can be configured to enable some basic subjective tuning through the configuration file. When enabled, the VTM attenuates the application of CC-ALF in regions that are coded with high QP and are either near mid-grey or contain a large amount of luma high frequencies. Algorithmically, this is accomplished by disabling the application of CC-ALF in CTUs where any of the following conditions are true:
The slice QP value minus 1 is less than or equal to the base QP value.
The number of chroma samples for which the local contrast is greater than (1<<(bitDepth−2))−1 exceeds the CTU height, where the local contrast is the difference between the maximum and minimum luma sample values within the filter support region.
More than a quarter of chroma samples are in the range between (1<<(bitDepth−1))−16 and (1<<(bitDepth−1))+16

The motivation for this functionality is to provide some assurance that CC-ALF does not amplify artefacts introduced earlier in the decoding path (This is largely due the fact that the VTM currently does not explicitly optimize for chroma subjective quality). It is anticipated that alternative encoder implementations may either not use this functionality or incorporate alternative strategies suitable for their encoding characteristics.

### Filter Parameters Signalling

ALF filter parameters are signalled in Adaptation Parameter Set (APS). In one APS, up to 25 sets of luma filter coefficients and clipping value indexes, and up to eight sets of chroma filter coefficients and clipping value indexes could be signalled. To reduce bits overhead, filter coefficients of different classification for luma component can be merged. In slice header, the indices of the APSs used for the current slice are signalled.

Clipping value indexes, which are decoded from the APS, allow determining clipping values using a table of clipping values for both luma and Chroma components. These clipping values are dependent of the internal bitdepth. More precisely, the clipping values are obtained by the following formula:

AlfClip={round(2^{B-α*n}) for n∈[0 . . N−1]}

with B equal to the internal bitdepth, α is a pre-defined constant value equal to 2.35, and N equal to 4 which is the number of allowed clipping values in VVC. The AlfClip is then rounded to the nearest value with the format of power of 2.

In slice header, up to 7 APS indices can be signalled to specify the luma filter sets that are used for the current slice. The filtering process can be further controlled at CTB level. A flag is always signalled to indicate whether ALF is applied to a luma CTB. A luma CTB can choose a filter set among 16 fixed filter sets and the filter sets from APSs. A filter set index is signalled for a luma CTB to indicate which filter set is applied. The 16 fixed filter sets are pre-defined and hard-coded in both the encoder and the decoder.

For the chroma component, an APS index is signalled in slice header to indicate the chroma filter sets being used for the current slice. At CTB level, a filter index is signalled for each chroma CTB if there is more than one chroma filter set in the APS.

The filter coefficients are quantized with norm equal to 128. In order to restrict the multiplication complexity, a bitstream conformance is applied so that the coefficient value of the non-central position shall be in the range of −2⁷ to 2⁷−1, inclusive. The central position coefficient is not signalled in the bitstream and is considered as equal to 128.

### Adaptive Loop Filter in ECM

In ECM (Muhammed Coban, et al., “Algorithm description of Enhanced Compression Model (ECM 5)”, Joint Video Exploration Team (JVET) of ITU-T SG 16 WP 3 and ISO/IEC JTC 1/SC 29/WG 11, 26th Meeting, by teleconference, 20-29 Apr. 2022, Document JVET-Z2025), some changes have been made to ALF compared the ALF in the VVC standard as shown below.

### ALF Simplification

ALF gradient subsampling and ALF virtual boundary processing are removed. Block size for classification is reduced from 4×4 to 2×2. Filter size for both luma and chroma, for which ALF coefficients are signalled, is increased to 9×9.

ALF with Fixed Filters

To filter a luma sample, three different classifiers (C₀, C₁ and C₂) and three different sets of filters (F₀, F₁ and F₂) are used. Sets F₀ and F₁ contain fixed filters, with coefficients trained for classifiers C₀ and C₁. Coefficients of filters in F₂ are signalled. Which filter from a set Fᵢ is used for a given sample is decided by a class Cᵢ assigned to this sample using classifier Cᵢ.

### Filtering

At first, two 13×13 diamond shape fixed filters F₀ and F₁ are applied to derive two intermediate samples R₀(x, y) and R₁(x, y). After that, F₂ is applied to R₀(x, y), R₁(x, y), and neighbouring samples to derive a filtered sample as

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{21} {c}_{i} {g}_{i} ] ,$$

where f_{i,j} is the clipped difference between a neighbouring sample and current sample R(x, y) and g; is the clipped difference between Rᵢ₋₂₀(x, y) and current sample. The filter coefficients Cᵢ, i=0, . . . 21, are signalled.

### Classification

Based on directionality Dᵢ and activity Âᵢ, a class Cᵢ is assigned to each 2×2 block:

Cᵢ=Âᵢ*M_{D,i}+Dᵢ,

where M_{D,i} represents the total number of directionalities Dᵢ.

As in VVC, values of the horizontal, vertical, and two diagonal gradients are calculated for each sample using 1-D Laplacian. The sum of the sample gradients within a 4×4 window that covers the target 2×2 block is used for classifier C₀ and the sum of sample gradients within a 12×12 window is used for classifiers C₁ and C₂. The sums of horizontal, vertical and two diagonal gradients are denoted, respectively, as

$${g}_{h}^{i} , {g}_{v}^{i} , {g}_{d 1}^{i} and {g}_{d 2}^{i} .$$

The directionality Dᵢ is determined by comparing

$${r}_{h , v}^{i} = \frac{max ( {g}_{h}^{i} , {g}_{v}^{i} )}{min ( {g}_{h}^{i} , {g}_{v}^{i} )} , {r}_{d 1 , d 2}^{i} = \frac{max ( {g}_{d 1}^{i} , {g}_{d 2}^{i} )}{min ( {g}_{d 1}^{i} , {g}_{d 2}^{i} )} ,$$

with a set of thresholds. The directionality D₂ is derived as in VVC using thresholds 2 and 4.5. For D₀ and D₁, horizontal/vertical edge strength

$${E}_{H V}^{i}$$

and diagonal edge strength

$${E}_{D}^{i}$$

are calculated first. Thresholds Th=[1.25, 1.5, 2, 3, 4.5, 8] are used. Edge strength

$${E}_{H V}^{i}$$

is 0 if

$${r}_{h , v}^{i} \leq Th [ 0 ] ;$$

otherwise,

$${E}_{H V}^{i}$$

is the maximum integer such that

$${r}_{h , v}^{i} > T h [ {E}_{H V}^{i} - 1 ] .$$

Edge strength

$${E}_{D}^{i}$$

is 0 if

$${r}_{d 1 , d 2}^{i} \leq T h [ 0 ] ;$$

otherwise

$${E}_{D}^{i}$$

is the maximum integer such that

$${r}_{d 1 , d 2}^{i} > T h [ {E}_{D}^{i} - 1 ] .$$

### When

$${r}_{h , v}^{i} > {r}_{d 1 , d 2}^{i} ,$$

i.e., horizontal/vertical edges are dominant, the Dᵢ is derived by using Table 2A; otherwise, diagonal edges are dominant, the Dᵢ is derived by using Table 2B.

TABLE 2A
$Mapping of {E}_{D}^{i} and {E}_{HV}^{i} to {D}_{i}$

| | ${E}_{D}^{i}$ | | | | | | |
|---|---|---|---|---|---|---|---|
| ${E}_{HV}^{i}$ | 0 | 1 | 2 | 3 | 4 | 5 | 6 |
| 0 | 0 | 0 | 0 | 0 | 0 | 0 | 0 |
| 1 | 1 | 2 | 0 | 0 | 0 | 0 | 0 |
| 2 | 3 | 4 | 5 | 0 | 0 | 0 | 0 |
| 3 | 6 | 7 | 8 | 9 | 0 | 0 | 0 |
| 4 | 10 | 11 | 12 | 13 | 14 | 0 | 0 |
| 5 | 15 | 16 | 17 | 18 | 19 | 20 | 0 |
| 6 | 21 | 22 | 23 | 24 | 25 | 26 | 27 |

TABLE 2B
$Mapping of {E}_{D}^{i} and {E}_{HV}^{i} to {D}_{i}$

| | ${E}_{HV}^{i}$ | | | | | | |
|---|---|---|---|---|---|---|---|
| ${E}_{D}^{i}$ | 0 | 1 | 2 | 3 | 4 | 5 | 6 |
| 0 | 28 | 0 | 0 | 0 | 0 | 0 | 0 |
| 1 | 29 | 30 | 0 | 0 | 0 | 0 | 0 |
| 2 | 31 | 32 | 33 | 0 | 0 | 0 | 0 |
| 3 | 34 | 35 | 36 | 37 | 0 | 0 | 0 |
| 4 | 38 | 39 | 40 | 41 | 42 | 0 | 0 |
| 5 | 43 | 44 | 45 | 46 | 47 | 48 | 0 |
| 6 | 49 | 50 | 51 | 52 | 53 | 54 | 55 |

To obtain Âᵢ, the sum of vertical and horizontal gradients Aᵢ is mapped to the range of 0 to n, where n is equal to 4 for Â₂ and 15 for Â₀ and Â₁.

In an ALF_APS, up to 4 luma filter sets are signalled, each set may have up to 25 filters.

### Bilateral Filter in ECM

The filter is carried out in the sample adaptive offset (SAO) loop-filter stage, as shown in FIG. 5. Both the bilateral filter (BIF) 510 and SAO 520 are using samples from deblocking as input. Each filter creates an offset per sample, and these are added (via adder 530) to the input sample and then clipped (by Clip module 540), before proceeding to ALF.

In detail, the output sample I_{OUT} is obtained as

I_{OUT}=clip3(I_{C}+ΔI_{BIF}+ΔI_{SAO}), (1)

where I_{C} is the input sample from deblocking, ΔI_{BIF} is the offset from the bilateral filter and ΔI_{SAO} is the offset from SAO.

The implementation provides the possibility for the encoder to enable or disable filtering at the CTU and slice level. The encoder makes a decision by evaluating the RDO cost.

For CTUs that are filtered, the filtering process proceeds as follows. At the picture border, where samples are unavailable, the bilateral filter uses extension (sample repetition) to fill in unavailable samples. For virtual boundaries, the behaviour is the same as for SAO, i.e., no filtering occurs. When crossing horizontal CTU borders, the bilateral filter can access the same samples as SAO is accessing. As an example, if the centre sample I_{C} (see FIG. 6) is located on the top line of a CTU, I_{NW}, I_{A} and I_{NE} are read from the CTU above, just like SAO does, but I_{AA} is padded, so no extra line buffer is needed compared to JVET-P0073 (Jacob Ström, et al., “CE5-3.1 Combination of bilateral filter and SAO”, Joint Video Exploration Team (JVET) of ITU-T SG 16 WP 3 and ISO/IEC JTC 1/SC 29/WG 11, 16th Meeting: Geneva, CH, 1-11 Oct. 2019, Document JVET-P0073).

The samples surrounding the centre sample I_{C} are denoted according to FIG. 6, where A, B, L and R stands for above, below, left and right and where NW, NE, SW, SE stands for the diagonal direction such as north-west (NW). Likewise, AA stands for above-above, BB for below-below, etc. This diamond shape in ECM is different from JVET-P0073 which used a square filter support, not using I_{AA}, I_{BB}, I_{LL}, Or I_{RR}.

Each surrounding sample I_{A}, I_{R}, etc. will contribute with a corresponding modifier value μ_{ΔI}_{_{A}}, μ_{ΔI}_{_{R}}, etc. These are calculated the following way: starting with the contribution from the sample to the right, I_{R}, we calculate the difference

ΔI_{R}=(|I_{R}−I_{C}|+4)>>3, (2)

where |·| denotes absolute value. For data that is not 10-bit, we use ΔI_{R}=(|I_{R}−I_{C}|+2ⁿ⁻⁶)>>(n−7) instead, where n=8 for 8-bit data etc. The resulting value is now clipped so that it is smaller than 16:

sI_{R}=min(15,ΔI_{R}). (3)

The modifier value is now calculated as:

$${μ}_{Δ {I}_{R}} = \{ \begin{matrix}{LUT}_{R O W} [ {sI}_{R} ] , & if {I}_{R} - {I}_{C} \geq 0 , \\ - LU {T}_{R O W} [ {sI}_{R} ] & otherwise\end{matrix} \qquad ( 4 )$$

where LUT_{ROW}[ ] is an array of 16 values determined by the value of qpb=clip (0, 25, QP+bilateral_filter_qp_offset-17):
{0, 0, 0, 0, 0, 0, 0, 0, 0, 0, 0, 0, 0, 0, 0, 0,}, if qpb=0
{0, 1, 1, 1, 1, 0, 0, 0, 0, 0, 0, 0, 0, 0, 0, 0,}, if qpb=1
{0, 2, 2, 2, 1, 1, 0, 1, 0, 0, 0, 0, 0, 0, 0, 0,}, if qpb=2
{0, 2, 2, 2, 2, 1, 1, 1, 1, 1, 1, 1, 0, 1, 1, −1,}, if qpb=3
{0, 3, 3, 3, 2, 2, 1, 2, 1, 1, 1, 1, 0, 1, 1, −1,}, if qpb=4
{0, 4, 4, 4, 3, 2, 1, 2, 1, 1, 1, 1, 0, 1, 1, −1,}, if qpb=5
{0, 5, 5, 5, 4, 3, 2, 2, 2, 2, 2, 1, 0, 1, 1, −1,}, if qpb=6
{0, 6, 7, 7, 5, 3, 3, 3, 3, 2, 2, 1, 1, 1, 1, −1,}, if qpb=7
{0, 6, 8, 8, 5, 4, 3, 3, 3, 3, 3, 2, 1, 2, 2, −2,}, if qpb=8
{0, 7, 10, 10, 6, 4, 4, 4, 4, 3, 3, 2, 2, 2, 2, −2,}, if qpb=9
{0, 8, 11, 11, 7, 5, 5, 4, 5, 4, 4, 2, 2, 2, 2, −2,}, if qpb=10
{0, 8, 12, 13, 10, 8, 8, 6, 6, 6, 5, 3, 3, 3, 3, −2,}, if qpb=11
{0, 8, 13, 14, 13, 12, 11, 8, 8, 7, 7, 5, 5, 4, 4, −2,}, if qpb=12
{0, 9, 14, 16, 16, 15, 14, 11, 9, 9, 8, 6, 6, 5, 6, −3,}, if qpb=13
{0, 9, 15, 17, 19, 19, 17, 13, 11, 10, 10, 8, 8, 6, 7, −3,}, if qpb=14
{0, 9, 16, 19, 22, 22, 20, 15, 12, 12, 11, 9, 9, 7, 8, −3,}, if qpb=15
{0, 10, 17, 21, 24, 25, 24, 20, 18, 17, 15, 12, 11, 9, 9, −3,}, if qpb=16
{0, 10, 18, 23, 26, 28, 28, 25, 23, 22, 18, 14, 13, 11, 11, −3,}, if qpb=17
{0, 11, 19, 24, 29, 30, 32, 30, 29, 26, 22, 17, 15, 13, 12, −3,}, if qpb=18
{0, 11, 20, 26, 31, 33, 36, 35, 34, 31, 25, 19, 17, 15, 14, −3,}, if qpb=19
{0, 12, 21, 28, 33, 36, 40, 40, 40, 36, 29, 22, 19, 17, 15, −3,}, if qpb=20
{0, 13, 21, 29, 34, 37, 41, 41, 41, 38, 32, 23, 20, 17, 15, −3,}, if qpb=21
{0, 14, 22, 30, 35, 38, 42, 42, 42, 39, 34, 24, 20, 17, 15, −3,}, if qpb=22
{0, 15, 22, 31, 35, 39, 42, 42, 43, 41, 37, 25, 21, 17, 15, −3,}, if qpb=23
{0, 16, 23, 32, 36, 40, 43, 43, 44, 42, 39, 26, 21, 17, 15, −3,}, if qpb=24
{0, 17, 23, 33, 37, 41, 44, 44, 45, 44, 42, 27, 22, 17, 15, −3,}, if qpb=25

This is different from JVET-P0073, where 5 such tables are used, and the same table is reused for several qp-values.

As described in JVET-N0493 (Jacob Ström, et al., “CE1-related: Multiplication-free bilateral loop filter”, Joint Video Exploration Team (JVET) of ITU-T SG 16 WP 3 and ISO/IEC JTC 1/SC 29/WG 11, 14th Meeting: Geneva, CH, 19-27 Mar. 2019, Document JVET-N0493) section 3.1.3, these values can be stored using six bits per entry resulting in 26*16*6/8=312 bytes or 300 bytes if excluding the first row which is all zeros.

The modifier values for μ_{ΔI}_{_{L}}, μ_{ΔI}_{_{A}}, and μ_{ΔI}_{_{B}} are calculated from I_{L}, I_{A} and I_{B} in the same way. For diagonal samples I_{NW}, I_{NE}, I_{SE}, I_{SW}, and the samples two steps away I_{AA}, I_{BB}, I_{RR} and I_{LL}, the calculation also follows Equations (2) and (3), but uses a value shifted by 1. Using the diagonal sample I_{SE} as an example, we get

$${μ}_{Δ {I}_{S E}} = \{ \begin{matrix}{LUT}_{R O W} [ {sI}_{SE} ] >> 1 , & if {I}_{S E} - {I}_{C} \geq 0 , \\ - ( {LUT}_{R O W} [ {sI}_{SE} ] >> 1 ) & otherwise\end{matrix} \qquad ( 5 )$$

and the other diagonal samples and two-steps-away samples are calculated likewise. The modifier values are summed together

mₛᵤₘ=μ_{ΔI}_{_{A}}+μ_{ΔI}_{_{B}}+μ_{ΔI}_{_{L}}+μ_{ΔI}_{_{R}}+μ_{ΔI}_{_{NW}}+μ_{ΔI}_{_{NE}}+μ_{ΔI}_{_{SW}}+μ_{ΔI}_{_{SE}}+μ_{ΔI}_{_{AA}}+μ_{ΔI}_{_{BB}}+μ_{ΔI}_{_{LL}}+μ_{ΔI}_{_{RR}}. (6)

Note that μ_{ΔI}_{_{R}} equals −μ_{ΔI}_{_{A}} for the previous sample. Likewise, μ_{ΔI}_{_{A}} equals −μ_{ΔI}_{_{B}} for the sample above, and similar symmetries can be found also for the diagonal and two-steps-away modifier values. This means that in a hardware implementation, it is sufficient to calculate the six values μ_{ΔI}_{_{R}}, μ_{ΔI}_{_{B}}, μ_{ΔI}_{_{SW}}, μ_{ΔI}_{_{SE}}, μ_{ΔI}_{_{RR}} and μ_{ΔI}_{_{BB}} and the remaining six values can be obtained from previously calculated values.

The mₛᵤₘ value is now multiplied either by c=1, 2 or 3, which can be done using a single adder and logical AND gates in the following way:

cᵥ=k₁&(mₛᵤₘ<<1)+k₂&mₛᵤₘ, (7)

where & denotes logical AND and k₁ is the most significant bit of the multiplier c and k₂ is the least significant bit. The value to multiply with is obtained using the minimum block dimension D=min (width, height) as shown in Table below:
Table. Obtaining the c Parameter from the Minimum Size D=Min (Width, Height) of the block.

| Block type | D ≤ 4 | 4 < D < 16 | D ≥ 16 |
|---|---|---|---|
| Intra | 3 | 2 | 1 |
| Inter | 2 | 2 | 1 |

Finally, the bilateral filter offset ΔI_{BIF} is calculated. For full strength filtering, we use

ΔI_{BIF}=(cᵥ+16)>>5, (8)

whereas for half-strength filtering, we instead use

ΔI_{BIF}=(cᵥ+32)>>6. (9)

A general formula for n-bit data is to use

r_{add}=2^{14—n-bilateral_filter_strength}

r_{shift}=15-n-bilateral_filter_strength

ΔI_{BIF}=(cᵥ+r_{add})>>r_{shift}, (10)

where bilateral_filter_strength can be 0 or 1 and is signalled in the PPS (Picture Parameter Set).

In the present invention, a position-aware in-loop filtering technique is disclosed to improve the coding performance.

### BRIEF SUMMARY OF THE INVENTION

A method and apparatus for video coding using position-aware in-loop filtering are disclosed. According to the method, reconstructed pixels associated with a current coding region are received. A horizontal period M and a vertical period N are determined, wherein M and N are positive integers. Samples in the current coding region are divided into K positional groups according to sample positions with respect to the horizontal period M and the vertical period N, wherein K is a positive integer smaller than or equal to M×N. K in-loop filters are determined for the K positional groups, wherein any two of the K in-loop filters are different in at least one part of filtering process. A target filtered output for a target sample of the current coding region having a target positional group number is derived by applying a target in-loop filter to the target sample, wherein the target in-loop filter is selected from the K in-loop filters according to the target positional group number. Filtered-reconstructed pixels are provided, wherein the filtered-reconstructed pixels comprise the target filtered output.

In one embodiment, the K in-loop filters correspond to SAO (Sample Adaptive Offset) with K different classification rules or K different offsets. In another embodiment, the K in-loop filters correspond to BIF (Bilateral Filter) with K different lookup tables or K different intermediate filtering result derivation methods. In yet another embodiment, the K in-loop filters correspond to ALF (Adaptive Loop Filter) with K different classification rules or K different sets of coefficients. In yet another embodiment, the K in-loop filters correspond to one target in-loop filter with K different on/off control methods.

In one embodiment, said applying the target in-loop filter to the target sample is performed as a standalone process. In one embodiment, said applying the target in-loop filter to the target sample is performed between deblocking filtering and SAO (Sample Adaptive Offset)/BIF (Bilateral Filter). In another embodiment, said applying the target in-loop filter to the target sample is performed between SAO (Sample Adaptive Offset)/BIF (Bilateral Filter) and ALF (Adaptive Loop Filter). In yet another embodiment, said applying the target in-loop filter to the target sample is performed after ALF (Adaptive Loop Filter).

In one embodiment, said applying the target in-loop filter to the target sample is performed in parallel with SAO (Sample Adaptive Offset)/BIF (Bilateral Filter). In another embodiment, said applying the target in-loop filter to the target sample is performed in parallel with ALF (Adaptive Loop Filter). In yet another embodiment, said applying the target in-loop filter to the target sample is performed in parallel with deblocking filtering.

In one embodiment, one or more first flags indicating the horizontal period M and/or the vertical period N are signalled or parsed at CTB (Coding Tree Block), slice, or APS (Adaptation Parameter Set) level. In another embodiment, a second flag is signalled or parsed at the CTB, the slice, or the APS level to indicating whether to select the target in-loop filter from the K in-loop filters according to the target positional group number, and whether to derive the target filtered output for the target sample of the current coding region by applying the target in-loop filter to the target sample.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates the ALF filter shapes for the chroma (left) and luma (right) components.

FIGS. 3A-D illustrates the subsampled Laplacian calculations for gᵥ (3A), gₕ (3B), g_{d1} (3C) and g_{d2} (3D).

FIG. 4A illustrates the placement of CC-ALF with respect to other loop filters.

FIG. 4B illustrates a diamond shaped filter for the chroma samples.

FIG. 5 illustrates an example of Bilateral Filter (BIF) in ECM, where both BIF and SAO use samples from the deblocking stage as input and the outputs are combined and clipped before proceeding to ALF.

FIG. 6 shows the naming convention for samples surrounding the centre sample, I_{C} for BIF processing.

FIG. 7 illustrates an example of partitioning a coding region into M×N blocks and samples in each M×N block are divided into K(K<M×N) groups for selecting K at-least partially different in-loop filters.

FIG. 8 illustrates an example of partitioning a coding region into M×N blocks and samples in each M×N block are divided into K(K=M×N) groups for selecting K at-least partially different in-loop filters.

FIG. 9 illustrates a flowchart of an exemplary video coding system that utilizes position-aware reconstruction in in-loop filtering according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In the present invention, position-aware reconstruction is disclosed to improve the performance of ALF.

Position-Aware Reconstruction in in-Loop Filtering

In VVC in-loop filtering stage, the sample is processed by deblocking filtering, SAO, and ALF. In ECM, the sample is processed by deblocking filtering, SAO, BIF, and ALF with more complicated SAO and ALF design. In this invention, it is proposed to consider the positional information in the reconstruction process of in-loop filtering. The reconstruction process of in-loop filtering is also referred as the filtering process using an in-loop filter.

In one embodiment, a horizontal period M and a vertical period N are determined. The samples in a current coding region are divided into K groups based on M and N, and the samples in the different groups undergo partially different in-loop filtering mechanism at least. The difference can be different classification rules in SAO, different offsets in SAO, different look-up tables (LUT_{ROW}) in BIF, different intermediate filtering result (mₛᵤₘ, cᵥ, or ΔI_{BIF}) derivation methods in BIF, different classification rules in ALF, different set of coefficients in ALF, or different on/off control in the in-loop filtering process.

For example, let M=4 and N=2, given a current coding region, the samples in each M by N block are divided into K=6 groups, where the number in each small square indicates the group of the sample, and the group index can be 0, 1, 2, . . . , 5) as shown in FIG. 7. In FIG. 7, each small square represents a sample and the number in the small square is the positional group index assigned based on positional information of the sample. The example here shows that the number of group K is not necessarily equal to M×N (i.e., K(=6) not equal to 4×2 in this example). In other words, not every sample in an M by N block is categorized into a distinct group. In other words, some samples within an M×N block are assigned the same group index. In FIG. 7, a same positional group number is assigned to samples at a same corresponding positions within the M×N blocks. For example, if the upper-left corner coordinate of each M×N block is named as (0,0), the positional group number assigned to all sample locations at (0,0) of the M×N blocks in the current coding region is 0. The positional group number assigned to all sample locations at (0,1) or (1,0) of the M×N blocks is 1. Similarly, all sample locations at (2,0) of the M×N blocks in the current coding region is 3 and all sample locations at (3,0) of the M×N blocks in the current coding region is 4, and so on.

If SAO is used for the current coding region, the offset derivation process for each sample is affected by the positional group index. For example, 6 additional offsets C_{M}, C_{M+1}) . . . , C_{M+5} are signalled, and one or more of them will be added to the existing SAO offset for each sample according to the positional group index. As an example, denote the existing SAO offset for sample at (x, y) as C_{SAO} (x, y), the SAO reconstruction for samples with positional group index g becomes:

\tilde{R}(x,y)=R(x,y)+C_{M+g}+C_{SAO}(x,y),

where R(x, y) and \tilde{R}(x, y) are the current sample value before and after SAO reconstruction, respectively.

In another example, one new classifier which classifies the to-be-processed samples into different classes according to the positions of the to-be-processed samples and this pattern is added in SAO. That is, one additional mode can be used in SAO, compared to the original design. In another example, the samples in some specific group(s) are not filtered by SAO.

For another example, let M=4 and N=2, given a current coding region, the samples in each M by N block are divided into K=8 groups as shown in FIG. 8, where the number in the small square indicates the group index of the sample, and the group index can be 0, 1, 2, . . . , 7.

If ALF is used for the current coding region, the filtering process for each sample is affected by the positional group index. For example, in the ALF reconstruction equation

$$\tilde{R} ( x , y ) = R ( x , y ) + [ {\sum }_{i = 0}^{M - 1} {c}_{i} {n}_{i} ] ,$$

additional 8 coefficients C_{M}, C_{M+1}, . . . , C_{M+7} are signalled, and one or more of them will be introduced to the existing ALF filtering equation for each sample according to the positional group index. As an example, the ALF reconstruction becomes:
for samples with positional group 0:

$$\tilde{R} ( x , y ) = R ( x , y ) + [ {{\sum }_{i = 0}}^{M - 1} {c}_{i} {n}_{i} ] + {c}_{M}$$

for samples with positional group 1:

$$\tilde{R} ( x , y ) = R ( x , y ) + [ {\sum }_{i = 0}^{M - 1} {c}_{i} {n}_{i} ] + {c}_{M + 1}$$

for samples with positional group 2:

$$\tilde{R} ( x , y ) = R ( x , y ) + [ {\sum }_{i = 0}^{M - 1} {c}_{i} {n}_{i} ] + {c}_{M + 2}$$

for samples with positional group 3:

$$\tilde{R} ( x , y ) = R ( x , y ) + [ {\sum }_{i = 0}^{M - 1} {c}_{i} {n}_{i} ] + {c}_{M + 3}$$

for samples with positional group 4:

$$\tilde{R} ( x , y ) = R ( x , y ) + [ {\sum }_{i = 0}^{M - 1} {c}_{i} {n}_{i} ] + ( {c}_{M} + {c}_{M + 4} )$$

for samples with positional group 5:

$$\tilde{R} ( x , y ) = R ( x , y ) + [ {\sum }_{i = 0}^{M - 1} {c}_{i} {n}_{i} ] + ( {c}_{M + 1} + {c}_{M + 5} )$$

for samples with positional group 6:

$$\tilde{R} ( x , y ) = R ( x , y ) + [ {\sum }_{i = 0}^{M - 1} {c}_{i} {n}_{i} ] + ( {c}_{M + 2} + {c}_{M + 6} )$$

for samples with positional group 7:

$$\tilde{R} ( x , y ) = R ( x , y ) + [ {\sum }_{i = 0}^{M - 1} {c}_{i} {n}_{i} ] + ( {c}_{M + 3} + {c}_{M + 7} )$$

where R(x, y) and \tilde{R}(x, y) are the current sample value before and after ALF reconstruction, respectively.

In the above embodiment, additional flags can be signalled at CTB, slice, or APS level to indicate the period selection (i.e., M and N). Furthermore, additional flags can be signalled at CTB, slice, or APS level to indicate whether to use the positional information or not. If positional information is not used, the reconstruction process of in-loop filtering will follow the existing design.

In another embodiment, such positional-aware reconstruction is a standalone process rather than integrated with existing in-loop filtering tools. This process can be between deblocking filtering and SAO/BIF, between SAO/BIF and ALF, or after ALF. In another embodiment, this process can be executed in parallel with one of current in-loop filtering, e.g. deblocking filter, SAO/BIF, or ALF. And the final output will be the combination of this process and the one in-loop filtering which is performed in parallel. In one example, this process is added into the same stage of SAO/BIF. That is, after deblocking filter, the reconstructed picture will be restored by three kinds of in-loop filtering, SAO, BIF and the proposed position-aware reconstruction, in parallel, and the final output of this stage will be the combination of the outputs from these three in-loop filtering.

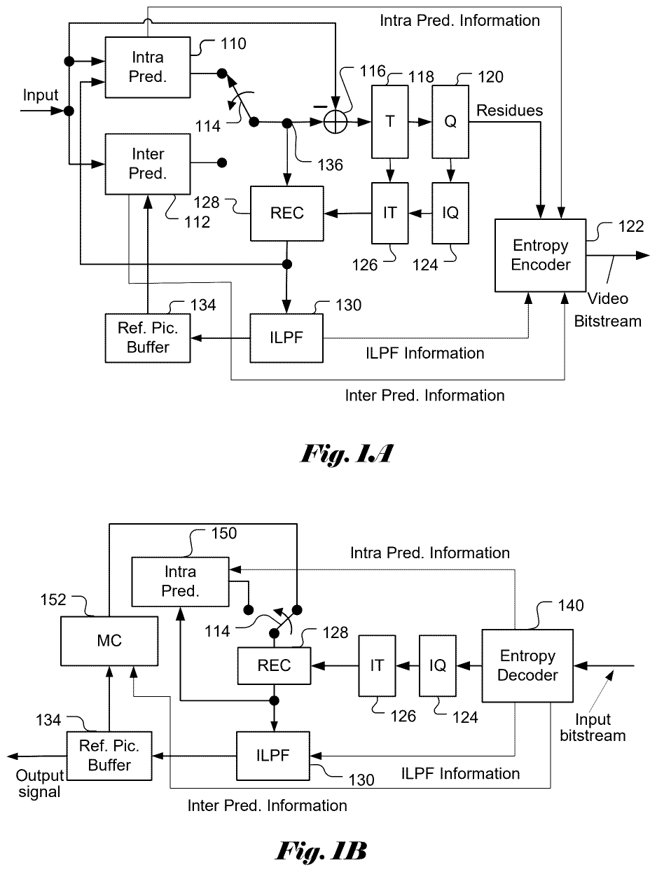

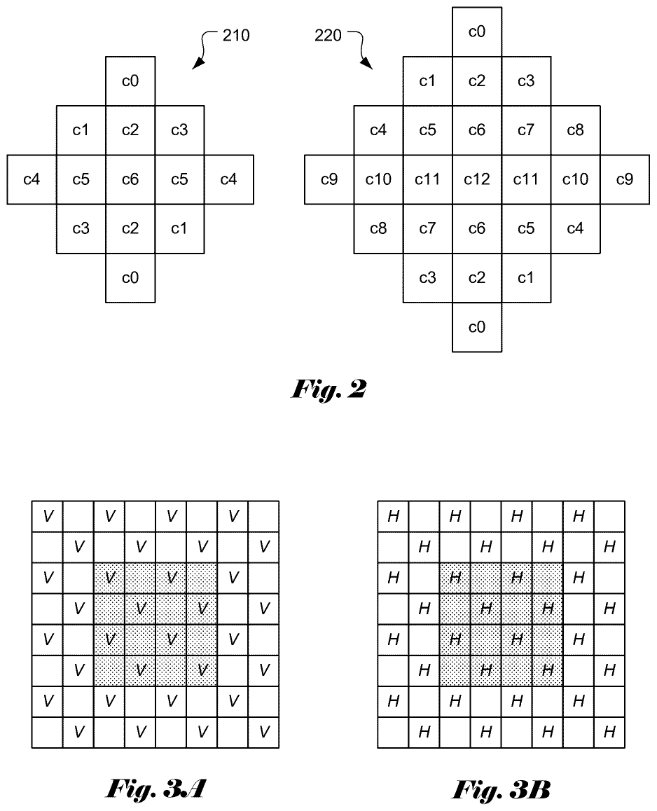

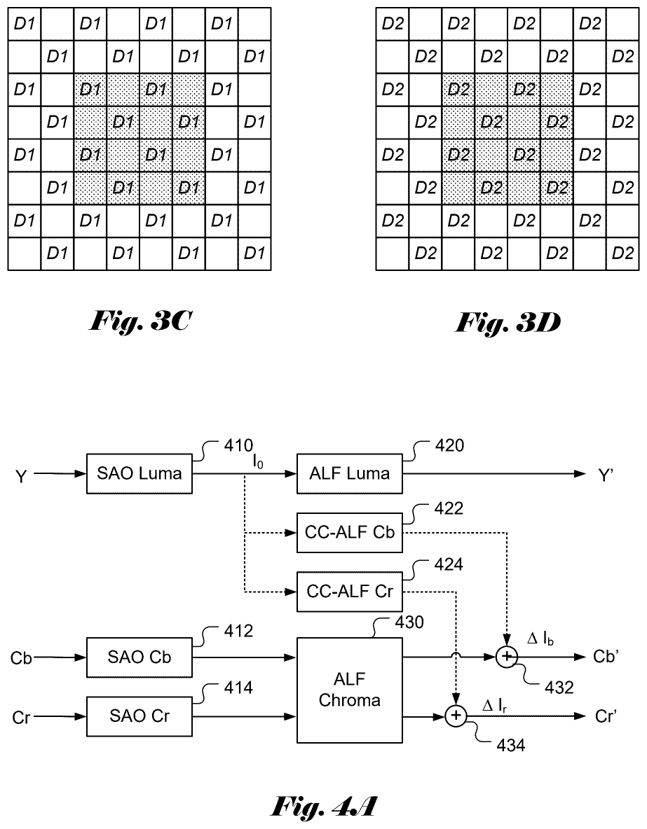

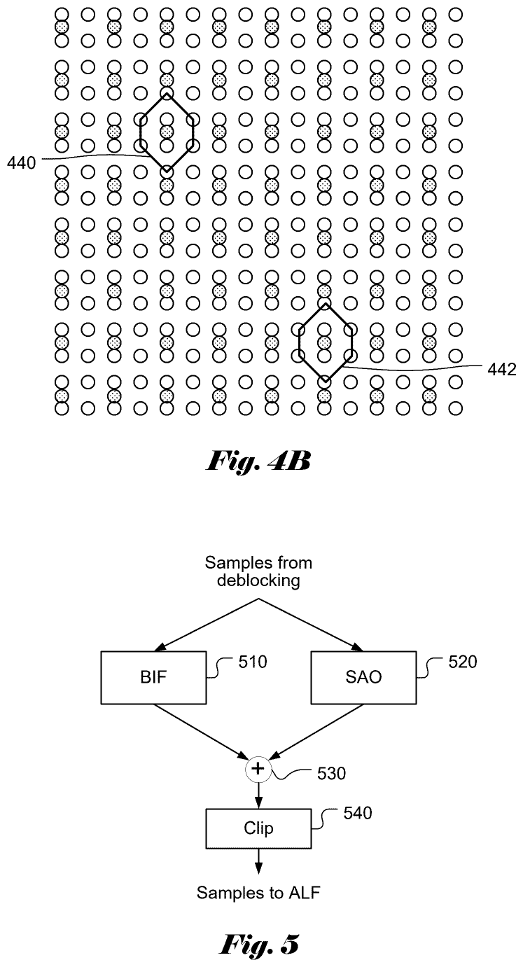

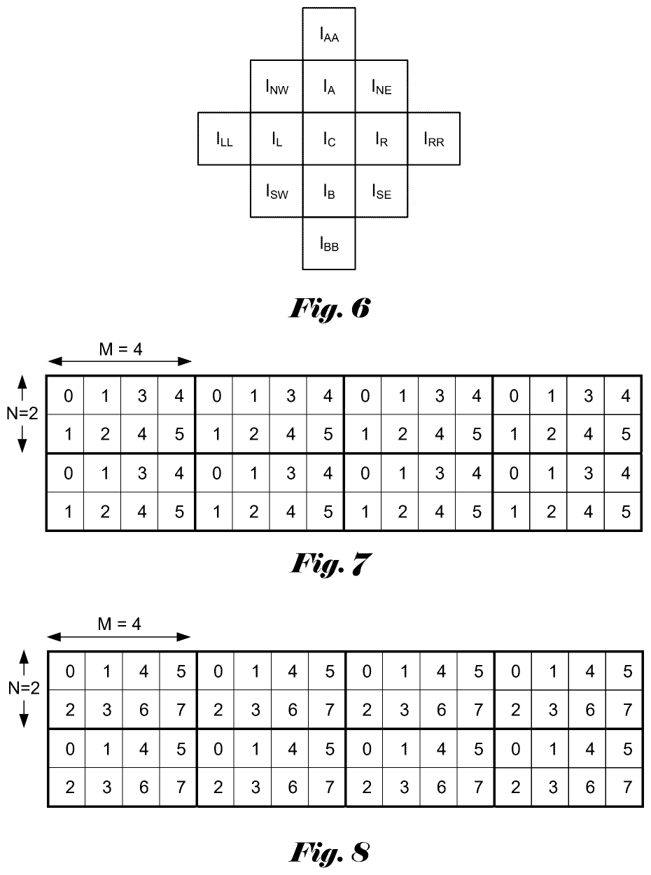

Any of the position-aware reconstruction in in-loop filtering as described above can be implemented in encoders and/or decoders. For example, any of the proposed methods can be implemented in the in-loop filter module (e.g. ILPF 130 in FIG. 1A and FIG. 1B) of an encoder or a decoder. Alternatively, any of the proposed methods can be implemented as a circuit coupled to the inter coding module of an encoder and/or motion compensation module, a merge candidate derivation module of the decoder. The ALF methods may also be implemented using executable software or firmware codes stored on a media, such as hard disk or flash memory, for a CPU (Central Processing Unit) or programmable devices (e.g. DSP (Digital Signal Processor) or FPGA (Field Programmable Gate Array)).

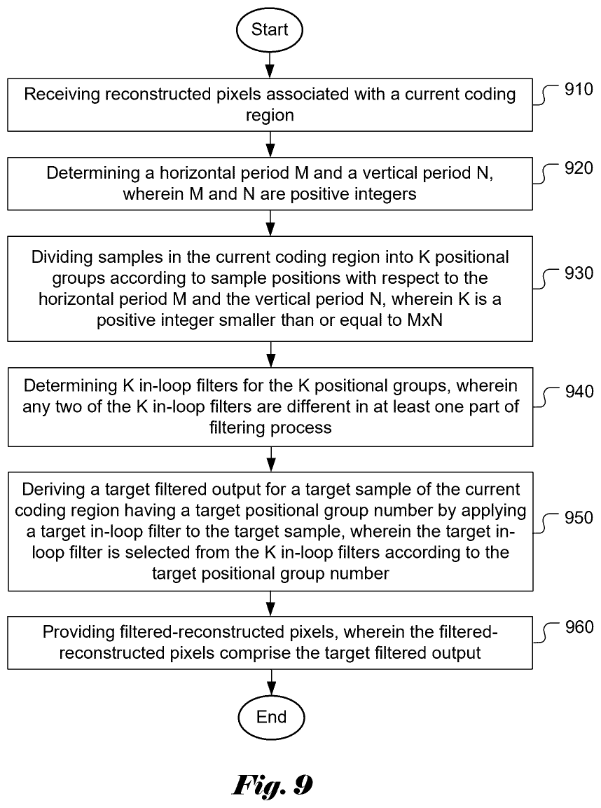

FIG. 9 illustrates a flowchart of an exemplary video coding system that utilizes position-aware reconstruction in in-loop filtering according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, reconstructed pixels associated with a current coding region are received in step 910. A horizontal period M and a vertical period N are determined in step 920, wherein M and N are positive integers. Samples in the current coding region are divided into K positional groups according to sample positions with respect to the horizontal period M and the vertical period N in step 930, wherein K is a positive integer smaller than or equal to M×N. K in-loop filters are determined for the K positional groups in step 940, wherein any two of the K in-loop filters are different in at least one part of filtering process. A target filtered output for a target sample of the current coding region having a target positional group number is derived by applying a target in-loop filter to the target sample, wherein the target in-loop filter is selected from the K in-loop filters according to the target positional group number in step 950. Filtered-reconstructed pixels are provided in step 960, wherein the filtered-reconstructed pixels comprise the target filtered output.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method for in-loop filter processing of reconstructed video, the method comprising:
receiving reconstructed pixels associated with a current coding region;
determining a horizontal period M and a vertical period N, wherein M and N are positive integers;
dividing samples in the current coding region into K positional groups according to sample positions with respect to the horizontal period M and the vertical period N, wherein K is a positive integer smaller than or equal to M×N;
determining K in-loop filters for the K positional groups, wherein any two of the K in-loop filters are different in at least one part of filtering process;
deriving a target filtered output for a target sample of the current coding region having a target positional group number by applying a target in-loop filter to the target sample, wherein the target in-loop filter is selected from the K in-loop filters according to the target positional group number; and
providing filtered-reconstructed pixels, wherein the filtered-reconstructed pixels comprise the target filtered output.

2. The method of claim 1, wherein the K in-loop filters correspond to SAO (Sample Adaptive Offset) with K different classification rules or K different offsets.

3. The method of claim 1, wherein the K in-loop filters correspond to BIF (Bilateral Filter) with K different lookup tables or K different intermediate filtering result derivation methods.

4. The method of claim 1, wherein the K in-loop filters correspond to ALF (Adaptive Loop Filter) with K different classification rules or K different sets of coefficients.

5. The method of claim 1, wherein the K in-loop filters correspond to one target in-loop filter with K different on/off control methods.

6. The method of claim 1, wherein said applying the target in-loop filter to the target sample is performed as a standalone process.

7. The method of claim 6, wherein said applying the target in-loop filter to the target sample is performed between deblocking filtering and SAO (Sample Adaptive Offset)/BIF (Bilateral Filter).

8. The method of claim 6, wherein said applying the target in-loop filter to the target sample is performed between SAO (Sample Adaptive Offset)/BIF (Bilateral Filter) and ALF (Adaptive Loop Filter).

9. The method of claim 6, wherein said applying the target in-loop filter to the target sample is performed after ALF (Adaptive Loop Filter).

10. The method of claim 6, wherein said applying the target in-loop filter to the target sample is performed in parallel with SAO (Sample Adaptive Offset)/BIF (Bilateral Filter).

11. The method of claim 6, wherein said applying the target in-loop filter to the target sample is performed in parallel with ALF (Adaptive Loop Filter).

12. The method of claim 6, wherein said applying the target in-loop filter to the target sample is performed in parallel with deblocking filtering.

13. The method of claim 1, wherein one or more first flags indicating the horizontal period M and/or the vertical period N are signalled or parsed at CTB (Coding Tree Block), slice, or APS (Adaptation Parameter Set) level.

14. The method of claim 13, wherein a second flag is signalled or parsed at the CTB, the slice, or the APS level to indicating whether to select the target in-loop filter from the K in-loop filters according to the target positional group number, and whether to derive the target filtered output for the target sample of the current coding region by applying the target in-loop filter to the target sample.

15. An apparatus for in-loop filter processing of reconstructed video, the apparatus comprising one or more electronics or processors arranged to:
receive reconstructed pixels associated with a current coding region;
determine a horizontal period M and a vertical period N, wherein M and N are positive integers;
divide samples in the current coding region into K positional groups according to sample positions with respect to the horizontal period M and the vertical period N, wherein K is a positive integer smaller than or equal to M×N;
determine K in-loop filters for the K positional groups, wherein any two of the K in-loop filters are different in at least one part of filtering process;
derive a target filtered output for a target sample of the current coding region having a target positional group number by applying a target in-loop filter to the target sample, wherein the target in-loop filter is selected from the K in-loop filters according to the target positional group number; and
provide filtered-reconstructed pixels, wherein the filtered-reconstructed pixels comprise the target filtered output.
